(19) United States
(12) Patent Application Publication
(10) Pub. No.: US 2023/0405538 A1
(43) Pub. Date: Dec. 21, 2023

(54) METHOD AND SYSTEM FOR GENERATING NANO- AND MICROBUBBLES

(71) Applicant: Hans Gude GUDESEN, Gamle Fredrikstad (NO)

(72) Inventor: Hans Gude GUDESEN, Gamle Fredrikstad (NO)

(21) Appl. No.: 18/038,017

(22) PCT Filed: Nov. 16, 2021
(86) PCT No.: PCT/NO2021/050239

§ 371 Date: May 20, 2023

(30) Foreign Application Priority Data
Nov. 20, 2020 (NO) 20201274

(51) Int. Cl. B01F 33/82; B01F 23/23; B01F 23/2375; B01F 27/053; B01F 25/314; B01F 27/1125; B01F 25/432; B01F 25/452

(52) U.S. Cl. CPC B01F 33/822; B01F 23/2319; B01F 23/2375; B01F 27/0531; B01F 25/3141; B01F 25/31425; B01F 27/11252; B01F 25/4322; B01F 25/45242; B01F 2101/305

(57) ABSTRACT

A fine bubbles generation system for converting gas into fine bubbles in liquid is disclosed. The system comprises a reactor vessel comprising gas input means (2), liquid input means (8), liquid output means, and agitation (7) and mechanical interaction means (11) arranged for providing fine bubble-laden liquid in a two-step process. A fine bubbles generation method for converting gas into fine bubbles in liquid is also disclosed.

### FIELD OF THE INVENTION

The present invention relates to a method and a system for generating gas-filled bubbles in water where the bubble diameters are in the nanometer and micrometer domain.

### BACKGROUND OF THE INVENTION

During recent years, various types of nano- and microbubble generators have been demonstrated, in response to perceived needs in a rapidly expanding range of applications that include waste water treatment, industrial flocculation processes, conditioning of habitats for aquatic flora and fauna, medical procedures, ultrasonic imaging, disinfection and cleaning, etc. Bubble generators may be based on generic principles such as venturi, liquid swirl, high pressure dissolution, ultrasonic vibration, electrolysis and nanopores. Of some relevance in the present context is a device described in U.S. Pat. No. 6,382,601 B1 by H. Ohnari: “Swirling fine-bubble generator”. Here, a swirling stream of water is mixed with air in a conical chamber before being ejected at high speed into surrounding water, causing vortex kinks and creating the fine bubbles. However, this device and most generator devices reported so far share a fundamental problem, namely high energy consumption and low capacity. This is a serious problem in many potential and important areas of application.

The Chinese utility application CN209065520U relates to the field of sewage treatment stirring aeration equipment, in particular to a full tooth blade swirl aerator. The Korean patent KR101947084B B1 relates to a nano-micro bubble generator having a structure designed to enhance collision and friction, two main factors in generating bubbles, and make introduced gas well dissolved into fluid. Both documents present traditional solutions for cavitation promoting materials such as machined, cast or woven edge, knife and mesh structures. For the importance of surface chemistry on nanobubble formation, see e.g.: S. Yang et al.: “Characterization of Nanobubbles on Hydrophobic Surfaces in Water”, Langmuir 2007, 23, 13, 7072-7077; https://doi.orq/10.1021/Ia070004i.

### SUMMARY OF THE INVENTION

A first aspect of the invention is a fine bubbles generation system for converting gas into fine bubbles in liquid where the system comprises
a reactor vessel comprising gas input means, liquid input means, and liquid output means;
agitation means arranged for agitating gas received through the gas input means and liquid received through the liquid input means, causing the liquid to take up gas in dissolved form and as first step bubbles, resulting in a first step gas-laden liquid; and
mechanical interaction means arranged for mechanical interaction with the first step gas-laden liquid creating cavitation bubbles and breaking up the cavitation bubbles and first step bubbles into smaller size second step bubbles resulting in a second step fine bubble-laden liquid; where the mechanical interaction means comprise impacting surfaces comprising nanocellulose in the form of cellulose nanofibers (CNF) and/or cellulose nanocrystals (CNC),
   where the agitation means and the mechanical interaction means are arranged in the reactor vessel between the gas input means and the liquid output means, the agitation means closest to the gas input means.

Optionally, the nanocellulose is derived from tunicates.

Optionally, the second step fine bubbles have a diameter less than 50 micrometers, or more less than 1 micrometer.

Optionally, the reactor vessel comprises a cylinder which can have a circular cross section and can be vertically arranged.

Optionally, the gas input means comprises a gas input opening in the reactor vessel and a fan or an impeller arranged in the reactor vessel between the gas input opening and the agitation means.

Optionally, the liquid input means comprises multiple injection nozzles arranged along wall a wall of the reactor vessel, where the multiple injections nozzles optionally are arranged for inputting the liquid in the reactor vessel there the agitation means are arranged.

Optionally, the agitation means comprises a cyclone comprising a driving impeller arranged in the reactor vessel and at least parts of the surrounding reactor wall, where optionally at least parts of the cyclone means being exposed within the reactor vessel, are topographically structured, and further optionally, at least parts of the cyclone means being exposed within the reactor vessel, are covered with asperity- and/or pore-containing materials. Optionally, the materials are fibrous and/or porous, and can optionally be nanocellulose, steel wool, glass or carbon fibers.

Optionally, the mechanical interaction means comprise multiple mutually angled or inclined surfaces arranged for cascading impacts with first step gas-laden liquid, and further optionally, at least parts of the mechanical interaction means are covered with asperity- and/or pore-containing materials. Optionally, the materials are fibrous and/or porous, and can optionally be nanocellulose, steel wool, glass or carbon fibers. Further optionally, the materials are nanocellulose in the form of cellulose nanofibers (CNF) and/or cellulose nanocrystals (CNC).

Optionally, the driving impeller is of a vornado type.

Optionally, the mechanical interaction means are arranged in a cavitation zone, and comprise pressure controlling impellers.

Optionally, the system comprises a bubble pump arranged to lift ejected water from the reactor vessel in a body of water.

A further aspect of the invention is a fine bubbles generation method for converting gas into fine bubbles in liquid, where the method comprises the following steps:
in a first step, bringing the gas into contact with the liquid under agitation causing the liquid to take up gas in dissolved form and as first step bubbles, and resulting in a first step gas-laden liquid; and
in a second step, subjecting the first step gas-laden liquid to at least one of i) pressure drops and ii) mechanical impacts, creating cavitation bubbles and breaking up the cavitation bubbles and first step bubbles into smaller size second step fine bubbles resulting in a second step fine bubble-laden liquid.

Optionally, the second step fine bubbles have a diameter less than 50 micrometers, and more preferably less than 1 micrometer.

### DESCRIPTION OF THE DIAGRAMS

The above and further features of the invention are set forth with particularity in the appended claims and together with advantages thereof will become clearer from consideration of exemplary embodiments of the invention given with reference to the accompanying drawing.

Embodiments of the present invention will now be described, by way of example only, with reference to the following diagram, wherein:

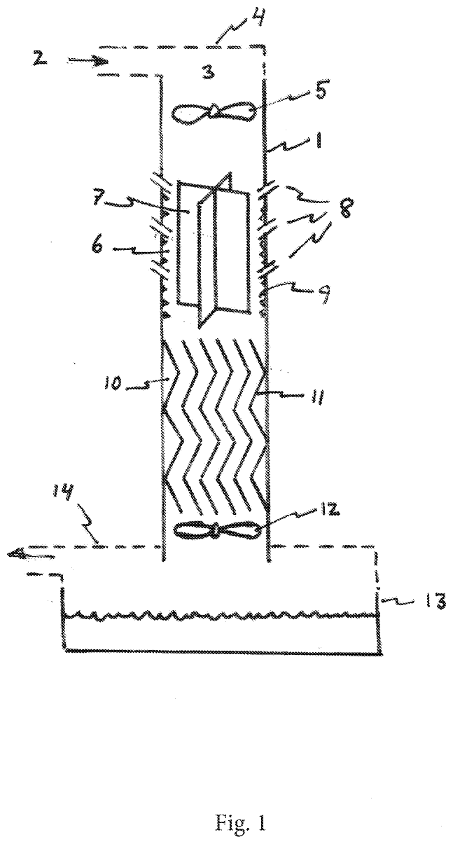

FIG. 1 shows a generic embodiment of a reactor according to the present invention.

### LIST OF REFERENCE NUMBERS IN THE FIGURES

The following reference numbers refer to the drawing:

Number Designation
1 Cylinder
2 Gas
3 Top of reactor vessel
4 First shroud
5 Fan/impeller
6 Vortex zone
7 Impeller
8 Injector devices
9 Wall integrated materials and structures
10 Cavitation zone
11 Cavitation objects
12 Impeller
13 Recipient
14 Second shroud

### DESCRIPTION OF PREFERRED EMBODIMENTS OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced, using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

According to the present invention a gas flow is converted into an aggregate of nano- and microbubbles in water, by carrying out the following steps:
In the first step, gas from a gas source is brought into intimate contact with water under strong agitation and in the presence of cavitation promoting surfaces and structures, causing the water to take up gas in the form of bubbles, dissolved gas and chemical reaction products.
In a second step, the water from the first step passes into a cavitation zone where bubbles are created and broken up into small size fractions with a significant proportion in the nano- and micro-size regime, by sudden pressure drops and mechanical impacts with cavitation promoting surfaces and structures. The microtopography and surface chemistry of these surfaces and structures are vitally important in the generation of the smallest bubble fractions. Based on extensive laboratory studies, the present invention identifies nanocellulose (cf., e.g.: https://en. wikipedia.org/wiki/Nanocellulose) as a particularly interesting class of cavitation promoting materials, with extremely sharp asperities and high porosities that are proving much superior to alternatives based on traditional solutions with machined, cast or woven edge, knife and mesh structures according prior art (see Background of the invention). Cellulose nanofibers (CNF) and cellulose nanocrystal (CNC) exhibit typical fibril widths ranging down to 5-15 nm, with high aspect ratios (1000), high mechanical strength and compatibility with a wide range of surface chemistry modifications. Nanocellulose has been created in aerogels with specific surface area from 250-350 m2/g at extremely low density (0.02 g/cm3) and at a porosity of 98%. Until recently, the major source of nanocellulose has been isolation from wood pulp, but during the last few years the present invention has been conceived and developed in parallel with the development of novel techniques for extraction and refinement of nanocellulose from tunicates: Tunicates, or sea squirts, are the only animals that can synthesize cellulose, which is different from plant cellulose: Cross-linking lignin and hemicellulose are absent, allowing easy extraction of high purity nanocellulose with fibrils that are longer, have a larger surface area and can easily be chemically modified to exhibit specific chemical affinities. The latter has been exploited to provide strong composites of tunicate nanocellulose with other materials, and to control hydrophobicity. Both of these traits are highly relevant and important in the construction of impact structures and their surfaces that interact with the flowing liquid in the cavitation zone to form micro- and nanobubbles.
The bubble-laden water from the second step may be released directly for end use or may pass through a separation step where any remaining bubbles in large size fractions are collected and recirculated, e.g. by aggregating gas from the bubbles by flotation and re-injecting it into the gas from a gas source referred in the first step above.

A first preferred embodiment of the invention is shown in FIG. 1: A reactor vessel in the form of a vertical cylinder (1) receives gas (2) through an opening at the top (3). The gas is transported downwards and is subjected to a series of treatments as it passes through the cylinder, as follows: The gas is injected into the cylinder by means of overpressure or suction, e.g. by the gas being fed at overpressure through a first shroud (4) enclosing the top of the cylinder, or with a fan or impeller (5) located near the top of the cylinder, or by underpressure provided by other elements inside the cylinder (not shown). The gas then enters a vortex zone (6) where an impeller (7) creates a swirling fluid motion coaxial with the cylinder. A number of injector devices (8) in the vortex zone spray water into the vortex, causing water to break up into droplets and mist that is carried along in the vortex motion. Being heavier than the gas, water droplets will be transported outwards, impact onto the cylinder wall and collect there, as is well known in the art of cyclone technology. The combined action of gas flow and gravity causes water that has accumulated at the cylinder wall to spiral downwards, along and in close proximity to the surface, under the constant agitation by the circulating gas. During this transport along the wall surface the gas and water mixture interacts with materials and structures (9) integrated into the wall and/or protruding from it, which further promotes formation of droplets and bubbles. The gas and water mixture is then fed into a cavitation zone (10) where the gas and water mixture is subjected to interactions with cavitation objects (11) that further break up droplets and bubbles and create ultrafine bubbles that may extend into the micro- and nanobubble domain. In the example shown in FIG. 1, the cavitation zone comprises a liquid conduit where the transmitted fluid cascades through a series of impact surfaces in the form of planar or curved plates oriented at an angle with the general flow direction of the fluid through the liquid conduit. The impact surfaces are covered with, or consist of nanocellulose to promote cavitation, e.g. cellulose nanofibers and/or nanocrystals in a random or structured packing pattern. An impeller (12) is positioned near the exit of the reactor vessel to assist in maintaining powerful interactions within the cavitation zone. Also, the impeller serves to lower the pressure in the cavitation zone and thus to promote the cavitation process. Finally, the water and gas mixture is collected in a recipient (13) which may include a second gas collection shroud (14).

In a preferred embodiment of the present invention, induction of gas into the reactor vessel and establishment of a vortex is achieved by means of a vornado type impeller, i.e. a dual function impeller where the vanes are shaped to transport gas axially while at the same time to set up an azimuthal circulation.

In another preferred embodiment of the present invention, the cavitation zone comprises a liquid conduit, e.g. a tube, which is loosely packed with a plug of fibers or particles made from one or more of the following: nanocellulose from tunicates or wood, fibers of metal, glass, carbon or minerals. The fibers or particles may be coated with chemically functional materials, e.g. hydrophobic. The packing shall be loose to ensure that the flow resistance through the cavitation zone is low.

In another preferred embodiment of the present invention, one or more impellers are positioned along the fluid path through the cavitation zone and optionally at its exit, creating local pressure drops associated with the impact surfaces, to promote creation of cavitation bubbles. The impellers may comprise surfaces that are covered by or consist of nanocellulose.

Fine bubbles generation systems according to the present invention may be located virtually anywhere, provided access to large volumes of water. In cases where the reactor is located in a body of water, energy can be saved by exploiting hydrostatic pressure in the surrounding water to force water injection into the reactor. However, bubble laden water ejected from the exit of the reactor shall take place against a hydrostatic pressure, consuming energy. One strategy to mitigate this problem is to exploit the fraction of entrained gas bubbles with sizes larger than the fine size fractions sought by the present invention: By transporting the bubble laden water ejected from the exit of the reactor in a vertical riser tube to the surface, the buoyancy of the large bubbles shall cause the riser tube to act as a bubble pump, as is well known in the art.

1. A fine bubbles generation system for converting gas into fine bubbles in liquid, where the system comprises:
a reactor vessel comprising gas input means, liquid input means, and liquid output means;
agitation means arranged for agitating gas received through the gas input means and liquid received through the liquid input means, causing the liquid to take up gas in dissolved form and as first step bubbles, resulting in a first step gas-laden liquid; and
mechanical interaction means arranged for mechanical interaction with the first step gas-laden liquid creating cavitation bubbles and breaking up the cavitation bubbles and first step bubbles into smaller size second step bubbles resulting in a second step fine bubble-laden liquid, where the mechanical interaction means comprise impacting surfaces comprising nanocellulose in the form of cellulose nanofibers (CNF) and/or cellulose nanocrystals (CNC),
where the agitation means and the mechanical interaction means are arranged in the reactor vessel between the gas input means and the liquid output means, the agitation means closest to the gas input means.

2. The fine bubbles generation system according to claim 1, where the nanocellulose is derived from tunicates.

3. The fine bubbles generation system according to claim 1, where the second step fine bubbles preferably have a diameter less than 50 micrometers, and more preferably less than 1 micrometer.

4. The fine bubbles generation system according to claim 1, where the reactor vessel comprises a cylinder.

5. The fine bubbles generation system according to claim 4, where the cylinder has a circular cross section and is vertically arranged.

6. The fine bubbles generation system according to claim 1, where the gas input means comprises a gas input opening in the reactor vessel and a fan or an impeller arranged in the reactor vessel between the gas input opening and the agitation means.

7. The fine bubbles generation system according to claim 1, where the liquid input means comprises multiple injection nozzles arranged along wall a wall of the reactor vessel.

8. The fine bubbles generation system according to claim 7, where the multiple injections nozzles are arranged for inputting the liquid in the reactor vessel there the agitation means are arranged.

9. The fine bubbles generation system according to claim 1, where the agitation means comprises a cyclone comprising a driving impeller arranged in the reactor vessel and at least parts of the surrounding reactor wall.

10. The fine bubbles generation system according to claim 9, where at least parts of the cyclone means being exposed within the reactor vessel, are topographically structured.

11. The fine bubbles generation system according to claim 10, where at least parts of the cyclone means being exposed within the reactor vessel, are covered with asperity- and/or pore-containing materials.

12. The fine bubbles generation system according to claim 11, where the materials are fibrous and/or porous.

13. The fine bubbles generation system according to claim 12, where the materials are nanocellulose, steel wool, glass or carbon fibers.

14. The fine bubbles generation system according to claim 1, where the mechanical interaction means comprise multiple mutually angled or inclined surfaces arranged for cascading impacts with first step gas-laden liquid.

15. The fine bubbles generation system according to claim 14, where at least parts of the mechanical interaction means are covered with asperity- and/or pore-containing materials.

16. The fine bubbles generation system according to claim 15, where the materials are fibrous and/or porous.

17. The fine bubbles generation system according to claim 16, where the materials are nanocellulose, steel wool, glass or carbon fibers.

18. The fine bubbles generation system according to claim 17, where the materials are nanocellulose in the form of cellulose nanofibers (CNF) and/or cellulose nanocrystals (CNC).

19. The fine bubbles generation system according to claim 9, where the driving impeller is of a vornado type.

20. The fine bubbles generation system according to claim 1, where the mechanical interaction means are arranged in a cavitation zone, and comprise pressure controlling impellers.

21. The fine bubbles generation system according to claim 1, comprising a bubble pump arranged to lift ejected water from the reactor vessel in a body of water.

22. A fine bubbles generation method for converting gas into fine bubbles in liquid, where the method comprises the following steps:
in a first step, bringing the gas into contact with the liquid under agitation causing the liquid to take up gas in dissolved form and as first step bubbles, and resulting in a first step gas-laden liquid; and
in a second step, subjecting the first step gas-laden liquid to at least one of i) pressure drops and ii) mechanical impacts, creating cavitation bubbles and breaking up the cavitation bubbles and first step bubbles into smaller size second step fine bubbles resulting in a second step fine bubble-laden liquid.

23. The fine bubbles generation method according to claim 22, where the second step fine bubbles preferably have a diameter less than 50 micrometers, and more preferably less than 1 micrometer.
